(19) United States
(12) Patent Application Publication
(10) Pub. No.: US 2013/0273797 A1
(43) Pub. Date: Oct. 17, 2013

(54) CONDUCTIVE POLYMER LAYERS GRAFTED ONTO INSULATING POLYMER SURFACES

(71) Applicant: E I DU PONT DE NEMOURS AND COMPANY, Wilmington, DE (US)

(72) Inventors: SIMONA PERCEC, PHILADELPHIA, PA (US); CONOR GORDON BOLAS, NEW ABBEY (GB)

(73) Assignee: E I DU PONT DE NEMOURS AND COMPANY, Wilmington, DE (US)

(21) Appl. No.: 13/826,655

(22) Filed: Mar. 14, 2013

Related U.S. Application Data
(60) Provisional application No. 61/625,276, filed on Apr. 17, 2012.

(51) Int. Cl. B05D 5/12; B05D 3/00; B05D 1/18

(52) U.S. Cl. CPC B05D 5/12; B05D 1/185; B05D 3/007
USPC 442/115; 427/393.5; 427/352; 428/473.5; 428/412; 428/480; 428/523; 428/474.4; 428/475.5; 428/421; 428/704

(57) ABSTRACT

This invention relates to electrically conductive polymers grafted to the surface of insulating polymers. Simultaneous polymerization and grafting reactions of conducting precursors form conductive polymer layers that dramatically increase the electrical conductivity of the respective insulating polymer films.

### FIELD OF THE INVENTION

This invention relates to processes for grafting electrically conductive polymers to the surfaces of insulating polymer articles.

### BACKGROUND

Most polymers are inherently electrical insulators. This property has been long exploited in applications where insulation and low electrical loss are important considerations (e.g., in wire covering, power cables, and electrically-powered component housings). However, there is also an interest in tailoring the electrical conductivity of polymers to make them useful in applications for which metals or other inorganic materials have traditionally been used.

Conductive polymer coatings on insulating polymers are conventionally obtained by mixing an insulating polymer with an already-made conductive polymer. Conductive polymers are typically obtained via chemical polymerization of their respective monomers in the presence of strong chemical oxidants. Chemical polymerization occurs in the bulk of the solution, and the resulting conductive polymers precipitate as solids that are insoluble in common solvents, infusible and decompose before melting. This makes it difficult to incorporate conductive polymers uniformly into other polymer matrices, and it is often necessary to grind the conducting polymer into small particles.

In some applications, the conductivity is required only on the surface of the insulating polymer film, and the conductive polymer particles present in the bulk are not contributing to the surface conductivity. This is an inefficient use of the often expensive conductive polymer material, and also provides surfaces with non-uniform conductivity. In addition, the conductive polymer particles are present as separate domains which can deteriorate the mechanical properties of the polymer matrix in which they are incorporated.

There is, therefore, a need for a process to create a robust, adherent layer of a conductive polymer on the surface of an insulating polymeric article such as a film.

### SUMMARY

In one aspect this invention pertains to a process comprising:
a) placing a polymer article in a solution comprising:
   i) a water-miscible alcohol;
   ii) a monomer selected from the group consisting of pyrrole, aniline, thiophene, carbazole, 5-amino-1-naphthol and derivatives thereof; and
   iii) a promoter;
b) adding an oxidant to the solution;
c) allowing the formation of a finished article; and
d) removing the finished article from the solution.

In another aspect of the invention pertains to finished articles formed by the present process.

In yet another aspect the invention pertains to articles comprising:
a) an insulating substrate; and
b) a conductive polymer grafted to the insulating substrate.

### DETAILED DESCRIPTION

The processes described herein transform a polymer from an insulator state to a conductive state, or any state in between insulating and conducting. The degree of conductivity can be tailored based on the types of monomer and oxidant, their concentration and reaction conditions such as time and temperature. The processes include polymerization of monomers and grafting reactions of conducting precursors, which reactions combine to form conductive polymer layers that increase the electrical conductivity of the insulating polymer articles.

Polymer articles can be in the form of films, sheets, woven or non-woven fabrics, molded pieces, extruded pieces, particles, beads, or fibers.

The polymer articles typically comprise polymers that comprise functional groups suitable for grafting, or have been surface-activated, e.g., via corona or chemical treatment. The polymer can optionally be formulated in a composition containing typical polymer additives such as fillers, pigments, surfactants, and rheology-modifying agents. Polyimide, polyamide, polyvinyl chloride, polyacrylonitrile, polycarbonate, poly(phenylene oxide), poly(vinyl butyral), poly(vinyl alcohol), poly(urethane), poly(sulfone), and Nafion® and Kapton® films and articles can typically be used without pre-treatment. Polyester, polystyrene, fluoro-olefin and polyolefin films and articles typically require pre-treatment.

In the process described herein, a polymer article is placed in a solution comprising: i) a water-miscible alcohol; ii) a monomer selected from the group consisting of pyrrole, aniline, thiophene, carbazole, and derivatives thereof; and iii) a promoter. When an oxidant is then added to the solution, an adherent layer of conductive polymer is formed on the surface of the polymer film or article, typically within a few seconds to several hours. After removing the polymer article from the solution, excess conductive polymer can optionally be removed from the surface.

Suitable water-miscible alcohols include linear C₁-C₆ alcohols and branched C₃-C₆ alcohols, e.g., methanol, ethanol, isopropanol and hexanol. Cyclic C₃-C₆ alcohols that are water-miscible can be used.

Suitable derivatives of pyrrole, aniline, thiophene, and carbazole include those derivatives comprising a functional group selected from the group consisting of: —COOH, —CN, —CH₂COOH, —CH₂CN, —CONH₂, —CO—NHNH₂, —CH₂CH₂NH₂, —CH₃, —OCH₃, and —C(O)COOH. In some embodiments, the derivatives comprise acidic groups that result in the formation of self-doped conducting polymers. Such derivatives include alkylsulfonate pyrrole and ring-substituted anilines comprising a sulfonic acid substituent. Suitable derivatives of pyrrole, aniline, thiophene, and carbazole also include: 3,4-ethylene dioxythiophene, N-methylpyrrole, 3-methylpyrrole, 3,5-dimethylpyrrole, 2,2′-bipyrrole, N-methylaniline, 2-methylaniline, 3-methylaniline, and N-phenyl-1,4-diaminobenzene.

A promoter, as used herein, is an agent promoting homogeneous polymerization of the monomer(s).

Suitable promoters include: triazole, oxadiazole, imidazole, quinoline, indole, pyrazole, pyrazine, benzimidazole, and para-phenylene diamine.

Suitable promoters for use with pyrrole and its derivatives include: imidazole, triazole, oxadiazole, indole, pyrazole, pyrazine, and benzimidazole.

Suitable promoters for use with aniline and its derivatives include: para-phenylene diamine and pyrrole.

Suitable promoters for use with thiophene and its derivatives include: pyrrole.

Suitable promoters for use with carbazole and its derivatives include: imidazole and pyrrole.

Suitable oxidants include: ammonium peroxydisulfate (APS), ammonium persulfate, iron (III) salts such as iron (III) chloride (FeCl₃) and iron (III) sulfate (Fe₂(SO₄)₃), permanganate salts, pentavalent molybdenum salts, Lu⁺³ salts, hydrogen peroxide, dicumyl peroxide, ammonium sulfur oxide-containing compounds such as (NH₄)₂S₂O₈, sodium sulfur oxide-containing compounds such as Na₂S₂O₈, potassium dichromate (K₂Cr₂O₇), nitric acid (HNO₃), perchloric acid (HClO₄), quinone, potassium ferricyanide (K₃(Fe(CN)₆)), phosphoric acid (H₃PO₄), molybdenum (VI) oxide (MoO₃), tungsten oxide (WO₃), chromium (VI) oxide (CO₃), ammonium cerium (III) sulfate ((NH₄)Ce(NO₃)₆), cerium sulfate (Ce(SO₄)₂), copper chloride (CuCl₂) and silver (I) nitrate (AgNO₃).

In carrying out the process, a solution is prepared, components of which include alcohol, monomer, a promoter, and optionally water. In some embodiments, the oxidant is dissolved in water before being added to the solution of alcohol, monomer and promoter.

The process can be conducted at a temperature of up to 100° C., depending on the boiling points and stability of the solution components. For convenience, the process can be conducted at room temperature, followed by washing and drying. The excess of the conducting polymer which is removed from the surface of the insulating coating by washing can be isolated by filtration and used in other applications.

The processes described herein can be used to tailor the electrical conductivity of the surface of many different polymers that are typically produced as films or textile assemblies, including woven and non-woven fabrics. The surfaces of these polymers can be changed uniformly or patterned with conductive lines or domains.

Some potential uses of the articles made by the processes disclosed herein include: 1) antistatic products (e.g., floor coverings, conveyor belts and tubes, stackable containers, playground equipment, and packaging for sensitive electronic components), in which the accumulation of the surface electrical charges must be eliminated or carefully controlled; 2) molded instrument housings and telecommunication equipment, which require shielding to mitigate electromagnetic interference effects; 3) heat sinks (e.g., cast thermosetting molds, thermoplastic bearings and moving parts); 4) polymer electrode materials; 5) printer belts; 6) flex circuits; and 7) components for audio-visual applications.

### EXAMPLES

General

Pyrrole, imidazole, and FeC₃•6H₂O were obtained from Sigma-Aldrich (St. Louis, Mo.). Kapton® film was obtained from DuPont Electronics & Communications (Circleville, Ohio). HDPE film (high density polyethylene, 1 mil) and LDPE film (low density polyethylene, 1 mil) were obtained from Blueridge Films, Inc. (Petersburg, Va.). Oriented polypropylene film (2 mil) was obtained from Plastic Suppliers, Inc. (Columbus, Ohio). Polycarbonate sheet (60 mil) was obtained from Kaufman Glass Company (New Castle, Del.). Mylar® film (1.42 mil) was obtained from DuPont Teijin Films (Chester, Va.). Nylon-6,6 membrane (hydrophilic, pore size 1 micron, 47 mm diameter) was obtained from EMD Millipore (Billerica, Mass.). Zytel® HTN501, a semi-aromatic polyamide (hexamethylene terephthalamide/2-methylpentamethylene terephthalamide copolyamide, polyamide 6,T/D,T), was obtained from E. I. du Pont de Nemours and Company (Wilmington, Del., USA). Two samples of Tedlar® films referred to as PV2111 and PV2001 were obtained from DuPont Photovoltaic Solutions (Wilmington, Del.). Delrin® 100P NC010 was obtained from DuPont Engineering Polymers (Wilmington, Del.).

The “rub test” consists of rubbing the upper half of films or fabrics with a tissue wipe, observing any conducting polymer removal, and then testing electrical resistance.

The “tape test” consists of applying a piece of Highland Invisible Tape (3M, St. Paul, Minn.) to films or fabrics, pulling off the tape, and noting whether any conducting polymer was removed.

### Example 1

This example demonstrates polypyrrole synthesized in-situ and grafted onto the surface of Kapton® film.

Pyrrole (0.3170) and imidazole (0.0750 g) were dissolved in methanol (50.0222 g) in a 400 mL beaker. A piece of Kapton® film (6 cm×6 cm) was fully submerged in the liquid with no bubbles present. FeCl₃•6H₂O (5.9711 g) was dissolved in deionized water (50.0 g) and then added to the beaker. Care was taken to make sure no bubbles were present and that the Kapton® was fully submersed. The solution turned from yellow to black over about 30 seconds and gave a slight exotherm. The beaker was covered with paraffin film and left to stand for about 20 h. After that time, the Kapton® film was hung to dry without washing or removing the polypyrrole (PPY) layer.

A thick, clumpy layer of PPY had coated the film evenly but was easily removed. Once dry, the film was wet briefly by re-immersion in the beaker. The film was then washed with water to remove the clumpy PPY layer. The film had gained a black tinge, but was totally homogeneous. The film was rinsed thoroughly with acetone, then rubbed with a tissue to remove the remaining PPY particles and dust.

The adhesion of the conductive PPY coating was tested by rubbing with cloths, scraping with spatulas and razor blades, and a tape-test. None of the conductive polymer coating was removed from the Kapton® film.

The surface electrical resistance of the PPY-treated Kapton film and of an untreated Kapton film was tested at multiple points on each sample using a PRS-801 Resistance System instrument from Prostat® Corporation, Bensenville, Ill., and the results are presented in Table 1. The pyrrole-treated Kapton® film showed a very low surface electrical resistance (1.91×10³ ohm), indicating a good conductivity compared to the untreated Kapton® film (3.3×10¹² ohm).

TABLE 1

| | | Average |
|---|---|---|
| | Surface | Resistance |
| Film | Resistance (Ω) | (Ω) |
| Untreated | 1.0 × 10¹², 2.2 × 10¹², 2.2 × 10¹², | 3.03 × 10¹² |
| Kapton ® | 4.6 × 10¹², 2.9 × 10¹², 5.3 × 10¹² | |
| PPY treated | 9.9 × 10², 9.8 × 10², 1.5 × 10³, | 1.91 × 10³ |
| Kapton ® | 9.8 × 10², 3.1 × 10³, 3.9 × 10³ | |

### Example 2

The preparation of the PPY-treated Kapton® film described in Example 1 was repeated. The surface resistance of the treated and untreated films was measured and the results are shown in Table 2.

TABLE 2

| | | | Average |
|---|---|---|---|
| | | Surface | Resistance |
| Film | | Resistance (Ω) | (Ω) |
| Untreated | | 1.1 × 10¹³, 6.0 × 10¹², 1.2 × 10¹³, | 1.02 × 10¹³ |
| Kapton ® | | 1.3 × 10¹², 1.6 × 10¹³, 1.5 × 10¹³ | |
| PPY-treated | Side 1 | 3.5 × 10³, 2.9 × 10³, 2.7 × 10³, | 1.91 × 10³ |
| Kapton ® | | 3.3 × 10³, 3.0 × 10³, 3.1 × 10³ | |
| | Side 2 | 5.1 × 10², 8.2 × 10², 9.5 × 10², | 8.83 × 10² |
| | | 8.3 × 10², 1.2 × 10³, 1.0 × 10³ | |

### Example 3

The conductivities of untreated and PPY-treated Kapton® films were measured before and after heating at 100° C. for 30 min. The results, shown in Table 3, indicate that the conductivity is substantially unchanged as a result of the heating.

TABLE 3

| | Avg. Resistance (Ω) | Avg. Resistance (Ω) |
|---|---|---|
| Film | Before Heating | After Heating |
| Untreated | 4.35 × 10¹² | 4.26 × 10¹² |
| Kapton ® | | |
| PPY-Treated | 3.18 × 10³ | 5.84 × 10³ |
| Kapton ® | | |

### Example 4

This example demonstrates the PPY treatment of four other polymers using the procedure of Example 1 and replacing the Kapton substrate with polycarbonate, Mylar®-DM, LDPE, or corona-treated Tyvek®. The amount of reagents used for each preparation are shown in Table 4. Average resistance and observations on each PPY-treated films are presented in Table 5.

TABLE 4

| | Imidazole | Pyrrole | Methanol | FeCl₃ | Water |
|---|---|---|---|---|---|
| Polymer | (g) | (g) | (g) | (g) | (g) |
| Polycarbonate | 0.0400 | 0.1384 | 25.0414 | 2.9636 | 25.1401 |
| Mylar ® | 0.0416 | 0.1515 | 24.9676 | 2.9570 | 25.1834 |
| LDPE | 0.0555 | 0.1533 | 25.0877 | 3.1085 | 24.9821 |
| Corona- treated | 0.0465 | 0.1550 | 25.1305 | 3.0399 | 25.0380 |
| Tyvek ® | | | | | |

TABLE 5

| | Average | |
|---|---|---|
| Polymer | Resistance (Ω) | Observations |
| PPY-treated | 8.34 × 10⁴ | Very smooth uniform film; resilient to |
| Polycarbonate | | the tape test; shiny metallic black |
| | | color. |
| PPY-treated | 2.3 × 10³ | Shiny metallic black color; uniform, |
| Mylar ® | | smooth film; removes easily and |
| | | cleanly with tape-test; portion under |
| | | film is insulating. |
| PPY-treated | 8.3 × 10⁵ | Film is patchy, with darker and lighter |
| LDPE | | areas; removes even with rubbing |
| | | with a cloth; comes off easily, but |
| | | unevenly, with tape-test. |
| PPY-treated | 3.27 × 10² | Tape-test removes fibers of Tyvek ®; |
| Tyvek ® | | black, non-shiny film; film is smooth |
| | | and uniform; fibers under the surface |
| | | are also blackened. |

### Example 5

This example demonstrates PPY treatment of Corona-treated polymers.

Four different polymer types—polypropylene (PP1 and PP2), LDPE, HDPE and Mylar® polyester (ML1 and ML2)—were corona-treated. Two samples of each polymer film were treated—one on one side only and the other on both sides. The power of electron beam was 300 Watts; the number of passes was 10; and the gap separation was 0.075″ for the HDPE, LDPE, PP2 and ML2 samples, which were all corona-treated on both sides. The PP1 and ML1 samples were corona-treated on just one side, using a hand-held device. The polymers were PPY-treated according to the procedure of Example 1. The properties of the resulting film, summarized in Table 6, demonstrate that corona treatment can be effective in increasing the adhesion of the conductive layer to the polymer.

TABLE 6

| | | PPY removed | Surface |
|---|---|---|---|
| Polymer | Side | in tape test? | Resistance (Ω) |
| HDPE | Corona-treated | No | 2.39 × 10³ |
| LDPE | Corona-treated | No | 2.26 × 10³ |
| PP1 | Corona Treated | No | 1.27 × 10³ |
| PP1 | Non-corona | Yes | 1.60 × 10³ |
| | Treated | | |
| PP2 | Corona-treated | No | 3.78 × 10³ |
| ML1 | Corona Treated | Yes | 2.73 × 10³ |
| ML1 | Non-corona | Yes | 1.75 × 10³ |
| | Treated | | |
| ML2 | Corona-treated | No | 26.25 × 10³ |

### Example 6

This example demonstrates the PPY treatment of nylon polymer films using the procedure of Example 1 and replacing the Kapton® substrate with nylon-6,6 or Zytel® HTN501.

The coatings appeared very uniform and homogeneous on both samples. The surface resistance was taken as an average of both sides of the film, and was 4.40×10⁵Ω for nylon-6,6 and 8.98×10⁷Ω for Zytel®. The coatings on both nylon samples were well-adhered, and neither came off with the tape test.

### Example 7

This example demonstrates the PPY treatment of two Tedlar® film samples, PV2111 and PV2001.

Imidazole (0.05 g) and pyrrole (0.14 g) were dissolved in methanol (25 g). The Tedlar® film was placed in a vessel containing the pyrrole/methanol/imidazole solution for about 5 min, and then a solution of 3.12 g of FeCl₃ dissolved in 25 g deionized water was quickly added to the vessel. The sample was moved around gently to displace any bubbles and to expose all of the Tedlar® film surface to the reaction mixture. The Tedlar® film was then left undisturbed in the reaction mixture for 23 hours before being hung to air-dry. After drying, the sample was rinsed in the reaction mixture to wash off the agglomerated pyrrole. The PPY-treated Tedlar® film sample was washed with acetone, rinsed with water, and then rubbed with a paper towel to remove any remaining PPY agglomerates. The surface resistance was taken as a six point average of both sides of the film.

The PPY formed a smooth, homogeneous, brown/black coating with no visible deformities except the small area where the sample was touching the glass vessel. Little or no variance was observed in the surface resistance measurements taken in different areas of the samples. The surface resistivity of the PPY-coated PV2001 sample was 1.83×10⁴Ω and that of the PPY-coated PV2111 sample was 1.09×10⁴Ω. The tape test did not cause delamination on either side of the two samples, indicating that the PPY adhered very strongly.

### Example 8

This example demonstrates the PPY treatment of Delrin® rods.

Ten Delrin® rods were suspended in a solution of methanol (600 g) imidazole (1.05 g) and pyrrole (3.52 g). A solution of FeCl₃ (56.3 g) in deionized water (700.1 g) was then added. The solutions were mixed with a spatula and the system was sealed in a polyethylene bag and allowed to stand undisturbed for about 20 hours. After this time, the rods were removed and hung to dry overnight. After drying, the samples were re-rinsed with the reaction mixture to wash off the agglomerated pyrrole; washed with acetone; re-rinsed with water; and then rubbed with a paper-towel to remove any remaining PPY agglomerates.

The surface resistance of the treated and untreated rods was determined. The resistance of the untreated rod was greater than 10¹²Ω, whereas the resistance of the PPY-treated rod decreased to about 10⁵Ω. The tape-test of was performed and it was found to partially remove a small amount of material from the Delrin surface.

The mechanical properties of rods were tested to determine if the acid from the FeCl₃ solution weakened the Delrin. The results of mechanical testing, summarized in Table 7, show that except for small reduction in elongation at break, the mechanical properties are substantially unchanged by the PPY treatment process.

TABLE 7

| | | Delrin ® Rod | Delrin ® Rod |
|---|---|---|---|
| Property | Units | Untreated | PPY-treated |
| Modulus | MPa | 3143 | 3116 |
| Tensile Strength | MPa | 73.5 | 73.4 |
| Yield Stress | MPa | 73.5 | 73.4 |
| Yield Strain | % | 26.7 | 26.7 |
| Elongation at | % | 35 | 29 |
| Break (nominal) | | | |
| Izod Notched | kJ/m² | 12.6 | 13.1 |
| Impact | | | |

What is claimed is:

1. A process comprising:
a) placing a polymer article in a solution comprising:
i) a water-miscible alcohol;
ii) a monomer selected from the group consisting of pyrrole, aniline, thiophene, carbazole, and derivatives thereof; and
iii) a promoter;
b) adding an oxidant to the solution;
c) allowing the formation of a finished article; and
d) removing the finished article from the solution.

2. The process of claim 1, further comprising allowing the finished article to dry.

3. The process of claim 2, further comprising returning the finished article to the solution.

4. The process of claim 3, further comprising removing the finished article from the solution and rinsing the article with a mixture of acetone and water.

5. A finished article formed by the process of claim 1.

6. An article comprising:
a) an insulating substrate; and
b) a conductive polymer grafted to the insulating substrate.

7. An article of claim 1, which is in the form of a film.
